(19) United States
(12) Patent Application Publication
(10) Pub. No.: US 2020/0167611 A1
(43) Pub. Date: May 28, 2020

(54) APPARATUS AND METHOD OF ENSURING QUALITY OF CONTROL OPERATIONS OF SYSTEM ON THE BASIS OF REINFORCEMENT LEARNING

(71) Applicant: ELECTRONICS AND TELECOMMUNICATIONS RESEARCH INSTITUTE, Daejeon (KR)

(72) Inventors: Seung Hyun YOON, Daejeon (KR); Seung Jae SHIN, Sejong-si (KR); Hong Seok JEON, Daejeon (KR); Chung Lae CHO, Daejeon (KR)

(73) Assignee: ELECTRONICS AND TELECOMMUNICATIONS RESEARCH INSTITUTE, Daejeon (KR)

(21) Appl. No.: 16/689,563

(22) Filed: Nov. 20, 2019

(30) Foreign Application Priority Data
Nov. 27, 2018 (KR) 10-2018-0148823

(51) Int. Cl. G06K 9/62; G06N 3/08; G06N 20/00

(52) U.S. Cl. CPC G06K 9/6265; G06N 20/00; G06N 3/08

(57) ABSTRACT

The present invention relates to a method and apparatus where a reinforcement learning agent ensures quality of an initial control operation of an environment on the basis of reinforcement learning, wherein a first action calculated by using an algorithm is selected at an initial learning stage, and a second action calculated by using a Q function is selected when the initial learning stage is ended.

### CROSS REFERENCE TO RELATED APPLICATION

The present application claims priority to Korean Patent Application No. 10-2018-0148823, filed Nov. 27, 2018, the entire contents of which is incorporated herein for all purposes by this reference.

### BACKGROUND OF THE INVENTION

### Field of the Invention

The present invention relates to an apparatus for controlling a system configured with various states by using a reinforcement learning method, and a method thereof.

### Description of the Related Art

FIG. 1 is a view showing a configuration diagram of a reinforcement learning system. Reinforcement learning is a method of automatically improving control quality (efficiency and accuracy) through interaction between an agent 110 and an environment 120 to be controlled.

The agent 110 may receive current state information (state) of the environment 120, and transfer an action in response to the same to the environment 120 by calculating the control action. The environment 120 may perform control according to the received control action, and transfer a result of performing the control action in a reward form to the agent 110. The agent 110 operates to improve the control action by adjusting the action by using a reward value such that the reward that will be accumulated later becomes maximum.

In reinforcement learning, the agent 100 has to determine a proper control action according to each state of the environment 120. However, when various states of the environment 120 are present, storing the above information in a conventional table or in a database form is difficult. Accordingly, recently, in techniques such as deep Q-network (DQN), learning for states and actions in association thereto are performed and operated in a neural network. The neural network used herein is used as an approximator (hereinafter, referred to as Q network) which calculates a control action according to a state.

As described above, a reinforcement learning agent may maintain interaction with the environment 120 in an initial state (in a Q network set to an arbitrary number), and operate to improve quality of a control action. Thus, quality of the control action calculated at the beginning may be bad, and control quality can be ensured only after learning proceeds to a certain level. Accordingly, at the beginning, applying the learning to the environment can be difficult.

Meanwhile, before using control technique based on AI such as reinforcement learning, when calculating a control action of the environment 120, a method of calculating on the basis of an algorithm is typically used. Particularly, when a model for calculating an optimized solution is complex, a method of determining an approximated solution by using a heuristic algorithm, etc. is often applied. These algorithms are generally developed by experts and have a certain level of quality, but improving control quality through methods such as reinforcement learning is impossible.

### SUMMARY OF THE INVENTION

Accordingly, the present invention has been made keeping in mind the above problems occurring in the related art, and the present invention provides an apparatus and method of combining a conventional method of ensuring a certain level of quality such as heuristic algorithm, and a reinforcement learning method.

According to a configuration of the present invention, at an initial learning stage where the learning is insufficient, an agent uses an existing algorithm, and the learning is performed on the basis of the same so as to ensure a certain level of quality.

It is to be understood that technical problems to be solved by the present disclosure are not limited to the aforementioned technical problems and other technical problems which are not mentioned will be apparent from the following description to a person with an ordinary skill in the art to which the present disclosure pertains.

According to the present invention, there is provided an apparatus for ensuring quality of control operations of a system wherein a reinforcement learning agent ensures quality of an initial control operation of an environment on the basis of reinforcement learning. Herein, the system includes the environment and the reinforcement learning agent.

According to an embodiment of the present invention, a method of ensuring quality of an initial control operation, wherein a reinforcement learning agent ensures quality of an initial control operation of an environment on the basis of reinforcement learning may be provided.

Also, according to an embodiment of the present invention, an apparatus for ensuring an initial control operation, wherein a reinforcement learning agent ensures quality of an initial control operation of an environment on the basis of reinforcement learning may be provided.

According to an embodiment of the present invention, an algorithm-based action calculation unit may calculate a first action by using an algorithm on the basis of state information.

According to an embodiment of the present invention, a Q function-based action calculation unit may calculate a second action by using a Q function on the basis of the state information.

According to an embodiment of the present invention, an evaluation and update unit may determine a learning state of a Q network, and selecting the first action or the second action.

According to an embodiment of the present invention, the state information is received from the environment, and when the selected action is transferred to the environment, the evaluation and update unit: selects the first action in an initial learning stage; determines whether or not to continue the initial learning stage on the basis of a result of the determined learning state of the Q network; and selects the second action when the initial learning stage is ended.

According to an embodiment of the present invention, the evaluation and update unit receives a reward value in association with a result of a control operation performed on the basis of the selected action, and updates the Q network on the basis of the reward value.

According to an embodiment of the present invention, when the learning state of the Q network is determined, the initial learning stage may be ended when an error value is smaller than a threshold error value and a number of times where the error value is determined to be smaller than the threshold error value is equal to a threshold value. Herein, a value function of the first action and a value function of the second action are evaluated, and the error value corresponds to a difference value between the value functions of the first action and the second action.

According to an embodiment of the present invention, when the learning state of the Q network is determined, a moving average value of an error value is calculated for a preset section, and the initial learning stage is ended when the error value is smaller than a threshold error value. Herein, a value function of the first action and a value function of the second action are evaluated, and the error value is a difference value between the value functions of the first action and the second action.

According to an embodiment of the present invention, the learning state of the Q network is determined, the initial learning stage is ended when a value of the first action and a value of the second action are identical and a number of times where the two values are determined to be identical is equal to a threshold number. According to an embodiment of the present invention, it can be easily used when the action space is discrete or when there are not many choices.

According to an embodiment of the present invention, the algorithm performs control for the environment, and corresponds to an algorithm capable of providing a certain level or higher of quality for the initial control operation of the environment during the initial learning stage.

According to an embodiment of the present invention, the algorithm corresponds to a heuristic algorithm.

The present invention provides a reinforcement learning method, wherein a system controls an environment that is controlled by using an existing control algorithm through reinforcement learning, the method includes: performing calculating by using the existing control algorithm at an initial learning stage, and at the same time, performing learning for the reinforcement learning agent so as to perform control while maintaining a certain level of quality at the beginning.

The present invention can solve reinforcement learning problems where quality is degraded at the initial learning stage.

The present invention can improve quality of system control through reinforcement learning.

Effects that may be obtained from the present disclosure will not be limited to only the above described effects. In addition, other effects which are not described herein will become apparent to those skilled in the art from the following description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a configuration diagram of a reinforcement learning system;

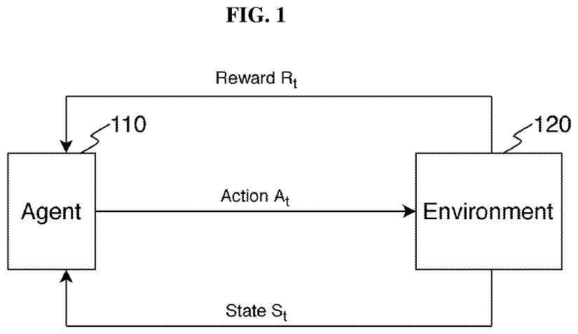

FIG. 2 is a view showing a configuration diagram of a reinforcement learning system according to an embodiment of the present invention;

FIG. 3 is a view showing a flowchart of a method of ensuring, by a reinforcement learning agent, quality of an initial control operation of an environment on the basis of reinforcement learning;

FIG. 4 is a view showing a process of a reinforcement learning method according to an embodiment of the present invention;

FIG. 5 is a view showing a process of a reinforcement learning method according to another embodiment of the present invention; and

FIG. 6 is a view showing a process of a reinforcement learning method according to still another embodiment of the present invention.

FIG. 7 is a block diagram illustrating a computing system for executing an apparatus and method for the reinforcement learning system according to an embodiment of the present invention.

### DETAILED DESCRIPTION OF THE INVENTION

Hereinbelow, exemplary embodiments of the present disclosure will be described in detail with reference to the accompanying drawings such that the disclosure can be easily embodied by one of ordinary skill in the art to which this disclosure belongs. However, the present disclosure is not limited to the exemplary embodiments.

In describing embodiments of the present disclosure, it is noted that when the detailed description of known configurations or functions related to the present disclosure may make the gist of the present disclosure unclear, the detailed description thereof will be omitted. Also, portions that are not related to the present disclosure are omitted in the drawings, and like reference numerals designate like elements.

In the present disclosure, when an element is “coupled to”, “combined with”, or “connected to” another element, it can be directly coupled to the other element or intervening elements may be present therebetween. Also, when a constituent “comprises” or “includes” an element, unless specifically described, the constituent does not exclude other elements but may further include the elements.

In the present disclosure, the terms “first”, “second”, etc. are only used to distinguish one element from another element. Unless specifically stated otherwise, the terms do not denote an order or importance. Thus, without departing from the scope of the present disclosure, a first element of an embodiment could be termed a second element of another embodiment. Similarly, a second element of an embodiment could also be termed a first element of another embodiment.

In the present disclosure, elements that are distinguished from each other to clearly describe each feature do not necessarily denote that the elements are separated. That is, a plurality of elements may be integrated into one hardware or software unit, or one element may be distributed into a plurality of hardware or software units. Accordingly, even if not mentioned, the integrated or distributed embodiments are included in the scope of the present disclosure.

In the present disclosure, elements described in various embodiments do not denote essential elements, and some of the elements may be optional. Accordingly, an embodiment that includes a subset of elements described in another embodiment is included in the scope of the present disclosure. Also, an embodiment that includes the elements which are described in the various embodiments and additional other elements is included in the scope of the present disclosure.

The present invention relates to a reinforcement learning system and method. According to the present invention, an environment system can be controlled as an existing method (ex. heuristic algorithm) in which control quality can be secured, and the reinforcement learning agent can be learned using the above-described method. Further, according to the present invention, it is possible to continuously improve the agent by using the reinforcement learning method when a certain level of quality is secured.

Hereinafter, the embodiments of the present disclosure will be described with reference to the accompanying drawings.

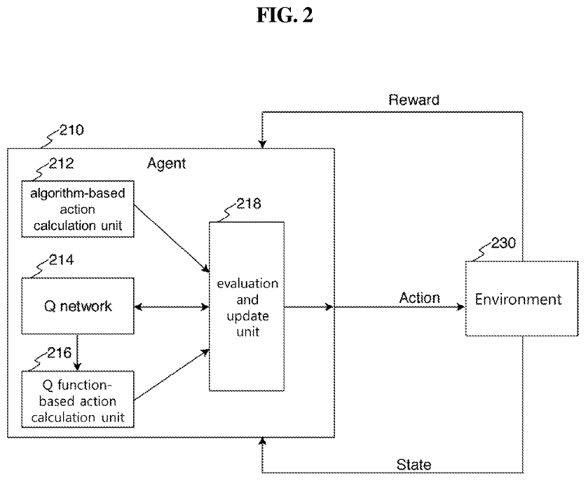

FIG. 2 is a view showing a configuration diagram of a reinforcement learning system according to an embodiment of the present invention.

A reinforcement learning process may operate in a manner known in the art.

Accordingly, first, an agent 210 may receive state information (state) from an environment 230. Subsequently, the agent 210 may calculate a control action on the basis of the current state information, and transfer the control action to the environment.

The environment 230 may perform the provided action, and calculate a reward. Subsequently, the environment 230 may transfer a reward value to the agent 210.

The agent may operate to improve the control action by adjusting the action by using the transferred reward value such that the reward that will be accumulated later becomes maximum.

The reinforcement learning agent 210 according to an embodiment of the present invention may be configured with an algorithm-based action calculation unit 212, a Q network 214, a Q function-based action calculation unit 216, and an evaluation and update unit 218.

Herein, the algorithm-based action calculation unit 212 may calculate an action on the basis of a known algorithm used in a control action (ex., Heuristic algorithm).

The Q network 214 may perform approximation for a Q function.

The Q function-based action calculation unit 216 may calculate an action on the basis of a Q network.

The evaluation and update unit 218 may perform evaluation for the calculated action, and update the Q network by receiving a reward.

A difference from an existing deep-Q network (DQN) is that the algorithm-based action calculation unit 212 and the evaluation and update unit 218 evaluating the calculated action and transferring a result of the same to the environment 120 are provided.

The reinforcement learning agent 210 according to the present invention may calculate each action by using all methods of calculating on the basis of the existing algorithm and calculating on the basis of a Q function when state information (state) is received from the environment 230.

The evaluation and update unit 218 may evaluate a learning state of the Q network by using the same. Herein, when it is determined that enough learning has not proceeded according to the evaluation, the evaluation and update unit 218 may transfer to the environment 120 an action calculated by using the existing algorithm. Subsequently, the evaluation and update unit 218 may update the Q network when a reward value (reward) is received from the environment 120, and adjust an evaluation level.

According to an embodiment of the present invention, the present invention may be applied to an IT infrastructure field such as network and cloud center. However, it is not limited thereto.

According to an embodiment of the present invention, the present invention may be applied to server scheduling for functions in a function as a service (FaaS), resource allocation problems, etc. Herein, in case of FaaS, when a request for performing a function is received in a controller, a factor to be determined may correspond to a function of scheduling a proper server (or virtual server or container). Herein, state information received in the agent from the environment 120 may correspond to a current usage rate of a server, a usage rate change in a predetermined period, a type and a feature of requested function, etc.

According to an embodiment of the present invention, the present invention may be applied to physical server allocation problems for a virtual server in an IaaS (Infra as a service). Herein, the present invention may perform a function of allocating a virtual server, which is requested as a factor to be determined, to a physical server within a cloud in accordance with a physical server resource, and a requested resource and performance. Herein, state information received in the agent from the environment 120 may correspond to a current usage rate/availability rate and history of each physical server, a performance of each physical server, a network performance according to a position of each physical server, etc.

According to an embodiment of the present invention, the present invention may be applied to network path determining problems. Herein, the present invention may perform a function of determining a network path when a packet arrives (ex., SDN environment) or when a request for calculating an end-to-end path arrives (ex. mainly occurring in a transmitting layer such as PTL, optical network, etc. or occurring in a path-connected network such as MPLS, etc.). Herein, state information received in the agent from the environment 120 may correspond to an amount of load and history of each link and a node resource, end-to-end performance information and history, etc.

According to an embodiment of the present invention, the present invention may be applied to problems such as storage location, replication action, etc. in a distributed storage function (big data platform: Hadoop, etc., distributed database: Cassandra, etc., P2P distributed file system: IPFS, etc.). Herein, the present invention may perform a function of determining to which location data is to be stored among nodes constituting a storage function when a request for storing the data is received from a user or system function. Herein, state information received in the agent from the environment 120 may include an access performance of each location, a capacity of each location, an availability rate of each location, each history, etc.

An environment to which the present invention is applied may correspond to a system for performing control management (scheduling, allocating, load distribution, etc.) in a computing, a networking, and a data storage device which are representative functional elements constituting an infrastructure.

In addition, state information may correspond to information required for determining factors to be determined according to each environment.

However, the system to which the present invention is applied is not limited to the above embodiment. In addition to the embodiments described above, problems in combination thereof or new problems may be further present. In addition, state information in the above embodiment is a simple example that is preferentially considered, and thus actually, more sophisticated state information design may be required.

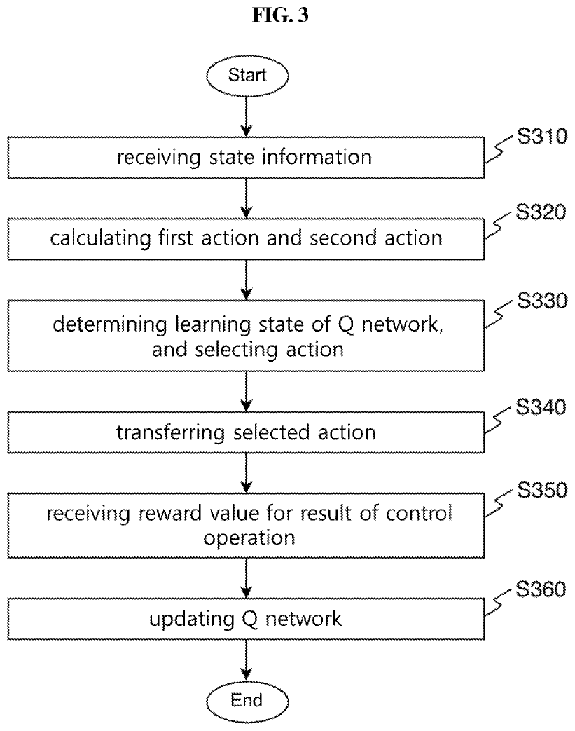

FIG. 3 is a view showing a flowchart of a method of ensuring, by a reinforcement learning agent, quality of an initial control operation of an environment on the basis of reinforcement learning.

The present invention may be employed in an apparatus where a reinforcement learning agent ensures quality of an initial control operation of an environment on the basis of reinforcement learning. Herein, the apparatus may include an algorithm-based action calculation unit, a Q function-based action calculation unit, a Q network unit, and an evaluation and update unit.

The present invention may be employed in a system where a reinforcement learning agent ensures quality of an initial control operation of an environment on the basis of reinforcement learning. Herein, the system may include an environment and a reinforcement learning agent.

In order to perform the method of the present invention, first, in S310, a reinforcement learning agent may receive state information (state) from an environment.

Subsequently, in S320, the reinforcement learning agent may calculate a first action and a second action. Herein, the first action calculated in the algorithm-based action calculation unit may correspond to an action calculated by using an algorithm on the basis of the state information. Herein, the second action calculated in the Q function-based action calculation unit may correspond to an action calculated by using a Q function on the basis of the state information.

According to an embodiment of the present invention, the algorithm may correspond to an algorithm performing control for the environment. The algorithm may correspond to an algorithm capable of providing a reference level or higher of quality for an initial control operation of the environment during an initial learning stage.

Herein, the reference quality may correspond to target quality when calculation is performed by using the algorithm. The corresponding reference quality may correspond to a value being capable set by a user. In addition, the reference quality may correspond to a value greater than a quality value that is obtained by calculating by using a reinforcement learning function. In other words, the reference quality may correspond to a value for better quality when technical problems of the system are calculated by using a reinforcement learning function. According to an embodiment of the present invention, the reinforcement learning function may correspond to a Q function.

In addition, according to an embodiment of the present invention, the algorithm may correspond to a heuristic algorithm.

In S330, the evaluation and update unit may determine a learning state of a Q network, and select the first action or the second action.

Herein, according to an embodiment of the present invention, the first action may be selected in an initial learning stage, and whether or not to continue the initial learning stage may be determined on the basis of the determined result of learning state of the Q network. Subsequently, when the initial learning stage is ended, the second action may be selected.

According to an embodiment of the present invention, when the evaluation and update unit determines a learning state of the Q network, the initial learning stage may be ended when an error value is smaller than a threshold error value and a number of times where the error value is determined to be smaller than the threshold error value is equal to a threshold number

Herein, a value function of the first action and a value function of the second action may be evaluated, and the error value may correspond to a difference value between the value functions of the first action and the second action.

In addition, the threshold error value is a reference for determining whether or not learning for a Q function represented in a Q network has proceeded closed to the existing algorithm quality, and may correspond to a value that may be set by the user.

Herein, the threshold number means a minimum number through which the second action calculated by using the Q function is selected rather than the first action calculated by using the algorithm, and may correspond to a value set that may be set by the user.

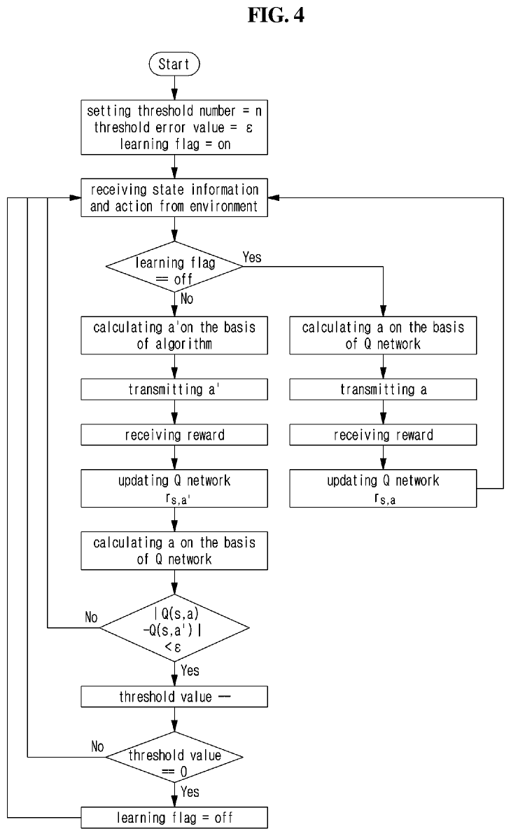

A detailed flow of the above determination method is described in detail with reference to FIG. 4.

According to an embodiment of the present invention, when the evaluation and update unit determines a Q network learning state, a moving average value of the error value may be calculated for a preset section, and the initial learning process may be ended when the error value is smaller than the threshold error value.

Herein, a value function of the first action and a value function of the second action may be evaluated, and the error value may correspond to a difference value between the value functions of the first action and the second action.

In addition, the threshold error value is a reference for determining whether or not learning for a Q function represented in a Q network has proceeded closed to the existing algorithm quality, and may correspond to a value that may be set by the user.

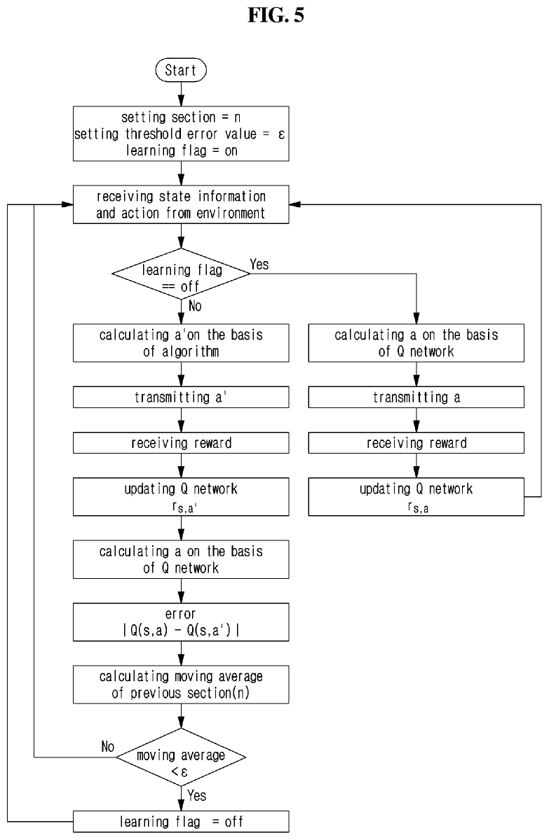

A detailed flow of the above determination method is described in detail with reference to FIG. 5.

According to an embodiment of the present invention, when the evaluation and update unit determines a Q network learning state, the initial learning stage may be ended when a value of the first action and a value of the second action are identical and a number of times where the values of the first action and the second action are determined to be identical is equal to a threshold value.

Herein, in order to ensure initial quality of the system, the threshold value may become a reference value for determining that the values of the first action and the second action are identical. The threshold value may correspond to a value that may be set by the user.

In addition, a case where the evaluation and update unit determines a Q network learning state as above may be used for a case where an action space is discrete or for a case where selectable factors are few.

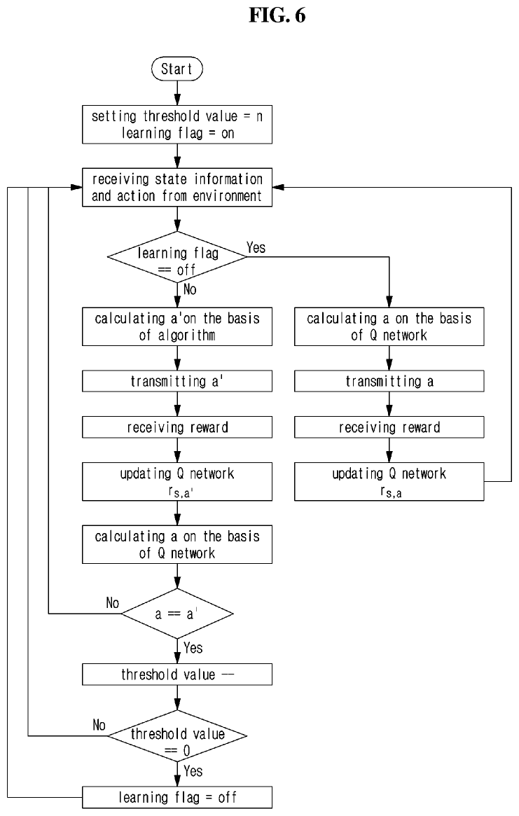

A detailed flow of the above determination method is described in detail with reference to FIG. 6.

In S340, the reinforcement learning agent may transfer the selected action to the environment. Subsequently, in S350, the reinforcement learning agent may receive a reward value for a result of the control operation performed on the basis of the selected action. Subsequently, in S360, the reinforcement learning agent may update the Q network on the basis of the reward value.

FIG. 4 is a view showing a process of a reinforcement learning method according to an embodiment of the present invention.

When a system begins, the agent may set a threshold number n, a threshold error value ε, and a learning flag for representing a learning level.

Herein, a value Q(s, a′) of an action a′ calculated by using an existing algorithm and a value Q(s, a) of an action a calculated by using reinforcement learning are evaluated, and the error value may correspond to a difference value between the two values.

Herein, the threshold error value ε may correspond to a limit of a designated error value. When the error value is smaller than the threshold error value, it may be used as an evaluation that learning for the Q function represented in the Q network is performed close to the existing algorithm quality.

When a number of times where the Q function is evaluated close to the algorithm quality is calculated and the calculated number becomes equal to the threshold number n, the method of using the existing algorithm may not be further used, and a method of using typical reinforcement learning may be used. In other words, the threshold number n may correspond to a reference value for operating the agent.

When the existing algorithm is used, a value of the learning flag may be set to “on”, and the same may represent an initial learning stage. When reinforcement learning is performed, the value of the learning flag is set to “off” so that control may be performed continuously by using a reinforcement learning method and updating the Q network may be performed. Thus, quality can be improved.

Describing the process in more detail, under a state where the above values are set, the agent may receive a state and an action request from the environment 120, and determine whether to transfer a control action based on an algorithm or to transfer a control action based on a Q network through the learning flag.

In a case based on an algorithm, an action a based on an algorithm is calculated and transferred to the environment 120, and a reward r_{s,a′} is received so as to update the Q network. When a state s is present, an action is calculated by using the updated Q network, and Q values Q(s, a′) and Q(s, a) of respective actions are calculated and a difference therebetween is compared.

When the difference is smaller than the threshold error value ε, the threshold number n is decreased by 1. When the threshold number n becomes 0, the learning flag is set to an “off” state, and thus it may represent a state where more algorithm-based action calculation and initial learning are unnecessary.

A state where a learning flag being an “off” state means that learning for the Q network is determined to be performed sufficiently close to the existing algorithm-based method so as to reach a certain level of quality, and thus subsequently, action calculation on the basis of reinforcement learning and updating the Q network may be continuously performed.

An additional embodiment shown in the following figure is a case where a reference for determining ending the initial learning is differently set.

FIG. 5 is a view showing a process of a reinforcement learning method according to another embodiment of the present invention.

An embodiment of FIG. 5 is a case where a moving average value of an error is calculated for a preset section n and the calculated moving average value is used rather than using an error value that is calculated for each time. When the moving average of the error is smaller than a predetermined threshold error value ε, the learning flag is set to an “off” state and the algorithm-based initial learning is ended.

Generally, in a learning stage, the error repeats increasing and decreasing rather than constantly decreasing, which tends to change significantly at the initial learning stage. However, when the learning has proceeded for some extent, the error value decreases gradually. An embodiment is used as a reference for determining the above error tendency, whether or not to end the initial learning stage is determined by using the moving average value of the error, and the above feature differs from the above-described one embodiment.

FIG. 6 is a view showing a process of a reinforcement learning method according to still another embodiment of the present invention.

In an embodiment of FIG. 6, whether or not to end an initial learning stage is determined on the basis of a number of times where results of algorithm-based calculation and Q function-based calculation are identical rather than using an evaluation value of the Q network. Although the two above-described embodiments have an advantageous aspect when an action space is consecutive or various selections are present, usage thereof is also advantageous when an action space is discrete and selectable factors are relatively few. In order to perform effective evaluation, the above method determines that learning is performed well when values of algorithm-based calculation and Q network-based calculation are identical.

However, in order to exclude a case where the two values coincide with a random chance, a threshold value may be set, and when a number of times where the two values coincide reaches the threshold value, a learning flag may be set to an “off” state so as to end the algorithm-based initial learning stage.

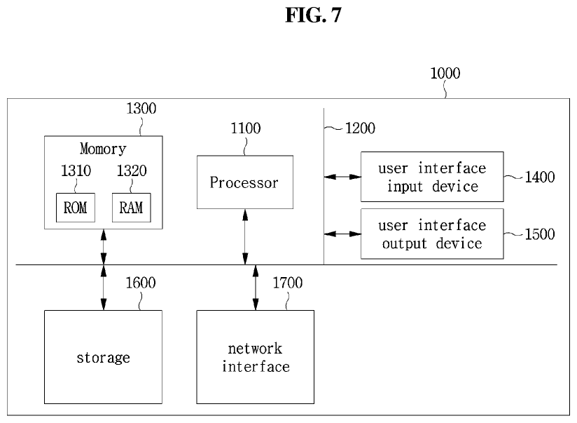

FIG. 7 is a block diagram illustrating a computing system for executing an apparatus and method for the reinforcement learning system according to an embodiment of the present invention.

Referring to FIG. 7, a computing system 1000 may include at least one processor 1100 connected through a bus 1200, a memory 1300, a user interface input device 1400, a user interface output device 1500, a storage 1600, and a network interface 1700.

The processor 1100 may be a central processing unit or a semiconductor device that processes commands stored in the memory 1300 and/or the storage 1600. The memory 1300 and the storage 1600 may include various volatile or nonvolatile storing media. For example, the memory 1300 may include a ROM (Read Only Memory) and a RAM (Random Access Memory).

Accordingly, the steps of the method or algorithm described in relation to the embodiments of the present disclosure may be directly implemented by a hardware module and a software module, which are operated by the processor 1100, or a combination of the modules. The software module may reside in a storing medium (that is, the memory 1300 and/or the storage 1600) such as a RAM memory, a flash memory, a ROM memory, an EPROM memory, an EEPROM memory, a register, a hard disk, a detachable disk, and a CD-ROM. The exemplary storing media are coupled to the processor 1100 and the processor 1100 can read out information from the storing media and write information on the storing media. Alternatively, the storing media may be integrated with the processor 1100. The processor and storing media may reside in an application specific integrated circuit (ASIC). The ASIC may reside in a user terminal. Alternatively, the processor and storing media may reside as individual components in a user terminal.

The exemplary methods described herein were expressed by a series of operations for clear description, but it does not limit the order of performing the steps, and if necessary, the steps may be performed simultaneously or in different orders. In order to achieve the method of the present disclosure, other steps may be added to the exemplary steps, or the other steps except for some steps may be included, or additional other steps except for some steps may be included.

Various embodiments described herein are provided to not arrange all available combinations, but explain a representative aspect of the present disclosure and the configurations about the embodiments may be applied individually or in combinations of at least two of them.

Further, various embodiments of the present disclosure may be implemented by hardware, firmware, software, or combinations thereof. When hardware is used, the hardware may be implemented by at least one of ASICs (Application Specific Integrated Circuits), DSPs (Digital Signal Processors), DSPDs (Digital Signal Processing Devices), PLDs (Programmable Logic Devices), FPGAs (Field Programmable Gate Arrays), a general processor, a controller, a micro controller, and a micro-processor.

The scope of the present disclosure includes software and device-executable commands (for example, an operating system, applications, firmware, programs) that make the method of the various embodiments of the present disclosure executable on a machine or a computer, and non-transitory computer-readable media that keeps the software or commands and can be executed on a device or a computer.

What is claimed is:

1. A method of ensuring quality of an initial control operation, wherein a reinforcement learning agent ensures quality of an initial control operation of an environment on the basis of reinforcement learning, the method comprising:
receiving state information from the environment;
calculating a first action by using an algorithm and calculating a second action by using a Q function on the basis of the state information;
determining a learning state of a Q network, and selecting the first action or the second action;
transferring the selected action to the environment;
receiving a reward value in association with a result of a control operation performed on the basis of the selected action; and
updating the Q network on the basis of the reward value,
wherein the first action is selected in an initial learning stage, whether or not to continue the initial learning stage is determined on the basis of a result of the determined learning state of the Q network, and the second action is selected when the initial learning stage is ended.

2. The method of claim 1, wherein in the determining of the learning state of the Q network, the initial learning stage in ended when an error value is smaller than a threshold error value, and a number of times where the error value is determined to be smaller than the threshold error value is equal to a threshold number.

3. The method of claim 2, wherein a value function of the first action and a value function of the second action are evaluated, and the error value is a difference value between the value functions of the first action and the second action.

4. The method of claim 1, wherein in the determining of the learning state of the Q network, a moving average value of an error value is calculated for a preset section, and the initial learning process is ended when the error value is smaller than a threshold error value.

5. The method of claim 4, wherein a value function of the first action and a value function of the second action are evaluated, and the error value is a difference value between the value functions of the first action and the second action.

6. The method of claim 1, wherein in the determining of the learning state of the Q network, the initial learning is ended when a value of the first action and a value of the second action are identical and a number of times where the two values are determined to be identical is equal to a threshold value.

7. The method of claim 1, wherein the algorithm performs control for the environment, and corresponds to an algorithm capable of providing a certain level or higher of quality for the initial control operation of the environment during the initial learning stage.

8. The method of claim 7, wherein the algorithm corresponds to a heuristic algorithm.

9. An apparatus for ensuring an initial control operation, wherein a reinforcement learning agent ensures quality of an initial control operation of an environment on the basis of reinforcement learning, the apparatus comprising:
an algorithm-based action calculation unit calculating a first action by using an algorithm on the basis of state information;
a Q function-based action calculation unit calculating a second action by using a Q function on the basis of the state information; and
an evaluation and update unit determining a learning state of a Q network, and selecting the first action or the second action,
wherein the state information is received from the environment, and when the selected action is transferred to the environment, the evaluation and update unit:
selects the first action in an initial learning stage;
determines whether or not to continue the initial learning stage on the basis of a result of the determined learning state of the Q network; and
selects the second action when the initial learning stage is ended.

10. The apparatus of claim 9, wherein the evaluation and update unit receives a reward value in association with a result of a control operation performed on the basis of the selected action, and updates the Q network on the basis of the reward value.

11. The apparatus of claim 9, wherein when determining the learning state of the Q network, the initial learning stage is ended when an error value is smaller than a threshold error value and a number of times where the error value is determined to be smaller than the threshold error value is equal to a threshold value.

12. The apparatus of claim 11, wherein a value function of the first action and a value function of the second action are evaluated, and the error value correspond to a difference value between the value functions of the first action and the second action.

13. The apparatus of claim 9, wherein when determining the learning state of the Q network, a moving average value of an error value is calculated for a preset section, and the initial learning stage is ended when the error value is smaller than a threshold error value.

14. The apparatus of claim 13, wherein a value function of the first action and a value function of the second action are evaluated, and the error value is a difference value between the value functions of the first action and the second action.

15. The apparatus of claim 9, wherein when determining the learning state of the Q network, the initial learning stage is ended when a value of the first action and a value of the second action are identical and a number of times where the two values are determined to be identical is equal to a threshold number.

16. The apparatus of claim 9, wherein the algorithm performs control for the environment, and corresponds to an algorithm capable of providing a certain level or higher of quality for the initial control operation of the environment during the initial learning stage.

17. A system for ensuring quality of an initial control operation, wherein a reinforcement learning agent ensures quality of an initial control operation of an environment on the basis of reinforcement learning, the system comprising:
the environment performing a control operation on the basis of an action selected by the reinforcement learning agent, and generating a reward value in association with a result of the control operation; and
the reinforcement learning agent,
wherein the reinforcement learning agent:
receives state information from the environment;
calculates a first action by using an algorithm on the basis of the state information, and calculates a second action by using a Q function on the basis of the state information;
determines a learning state of a Q network, and selects the first action or the second action;
transfers the selected action to the environment; and
receives the reward value, and updates the Q network on the basis of the reward value,
wherein the first action is selected in an initial learning stage, whether or not to continue the initial learning stage is determined on the basis of a result the determined learning state of the Q network, and the second action is selected when the initial learning stage is ended.
